(19) United States
(12) Patent Application Publication
(10) Pub. No.: US 2018/0053197 A1
(43) Pub. Date: Feb. 22, 2018

(54) NORMALIZING USER RESPONSES TO EVENTS

(71) Applicant: INTERNATIONAL BUSINESS MACHINES CORPORATION, Armonk, NY (US)

(72) Inventors: YUK L. CHAN, ROCHESTER, NY (US); HEIDI LAGARES-GREENBLATT, JEFFERSON HILLS, PA (US); JENNY S. LI, CARY, NC (US); DEEPTI M. NAPHADE, CUPERTINO, CA (US); XINLIN WANG, IRVINE, CA (US)

(21) Appl. No.: 15/240,388

(22) Filed: Aug. 18, 2016

(51) Int. Cl. G06Q 30/02; G06N 7/00

(52) U.S. Cl. CPC G06Q 30/0201; G06Q 50/01; G06N 7/005

(57) ABSTRACT

Embodiments include method, systems and computer program products for normalizing user responses to events. Aspects include receiving, by a processor, an indication of a level of satisfaction associated with an interaction by a user; receiving, by the processor, user data for the user; analyzing the user data to generate a normalized value of emotions of the user; and applying the normalized value to the indication of the level of satisfaction to generate a normalized level of satisfaction of the user associated with the interaction by the user.

### BACKGROUND

The present disclosure relates to responses to events and, more specifically, to methods and systems for normalizing user responses to events.

People react differently to external stimuli. In the realm of social media, a person may share personal experiences with various products and services providers, such as a restaurant. For example, a person may share on a social network that a local restaurant is pretty decent; while another person may share that the local restaurant's food is superb. Currently, there are many websites that display a composite review of goods and services based upon a combination of the reviews and ratings left by many individuals.

While each individual comment and rating can tend to show the quality of a product or service, it's not always a complete story behind the experience. An individual's emotional state at the time of using the product or service or at the time of posting the review could affect their experience in a positive or negative way that would not objectively determine a rating of the product or service.

### SUMMARY

Embodiments include a computer-implemented method for normalizing user responses to events. The method includes receiving, by a processor, an indication of a level of satisfaction associated with an interaction by a user; receiving, by the processor, user data for the user; analyzing the user data to generate a normalized value of emotions of the user; and applying the normalized value to the indication of the level of satisfaction to generate a normalized level of satisfaction of the user associated with the interaction by the user.

Embodiments include a computer system for normalizing user responses to events, the computer system including a processor, the processor configured to perform a method. The method includes receiving, by the processor, an indication of a level of satisfaction associated with an interaction by a user; receiving, by the processor, user data for the user; analyzing the user data to generate a normalized value of emotions of the user; and applying the normalized value to the indication of the level of satisfaction to generate a normalized level of satisfaction of the user associated with the interaction by the user.

Embodiments also include a computer program product for normalizing user responses to events, the computer program product including a non-transitory computer readable storage medium having computer readable program code embodied therewith. The computer readable program code including computer readable program code configured to perform a method. The method includes receiving, by a processor, an indication of a level of satisfaction associated with an interaction by a user; receiving, by the processor, user data for the user; analyzing the user data to generate a normalized value of emotions of the user; and applying the normalized value to the indication of the level of satisfaction to generate a normalized level of satisfaction of the user associated with the interaction by the user.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for normalizing user responses to events in accordance with one or more embodiments; and

FIG. 5 illustrates a flow diagram of a method for normalizing user responses to events in accordance with one or more embodiments.

### DETAILED DESCRIPTION

In accordance with exemplary embodiments of the disclosure, methods, systems and computer program products for normalizing user responses to events are provided. In one or more embodiments, methods for normalizing user responses to events include analyzing user data to determine a user's emotional state, which is represented by an emotional score. This user data can be obtained from social media and other sources regarding the user. The user data includes user demographic data, user historical data, and environmental data about the user. Based upon this user data, an emotional score can be determined. In exemplary embodiments, when a user has an experience with either a product or services, the emotional score can be used to normalize the user's response to this experience. For example, if a user is unhappy about losing his job and then makes a comment or provides a rating about a product or service or a company, this rating can be adjusted to account for the user's emotions at the time the rating or comment was made.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

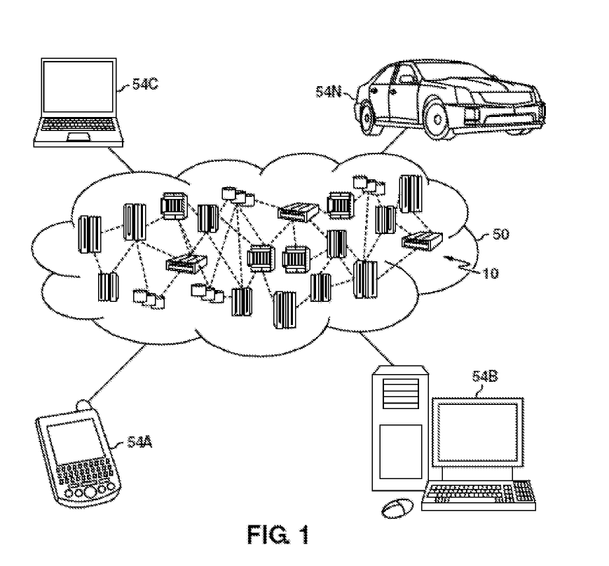

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

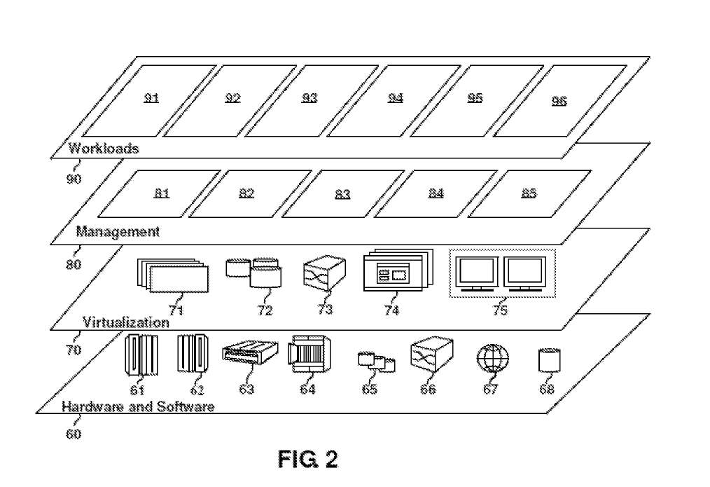

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and normalizing user responses to events 96.

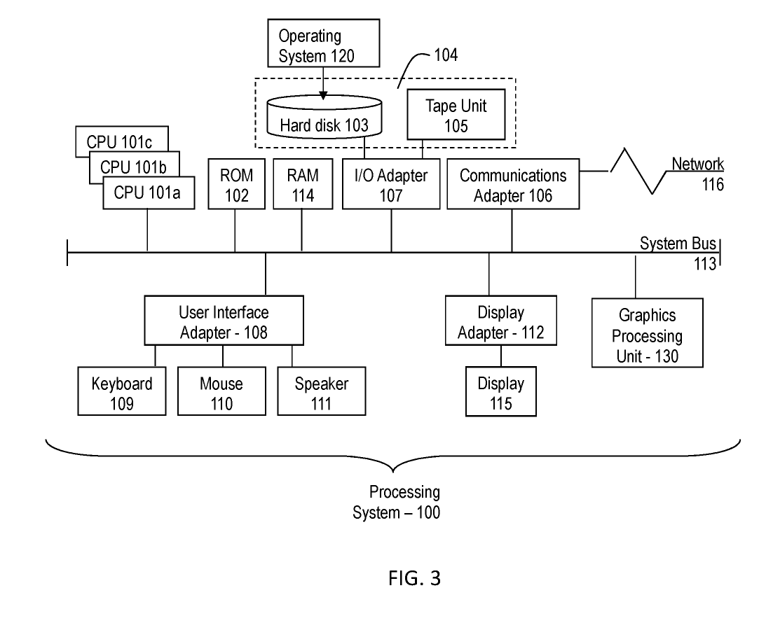

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

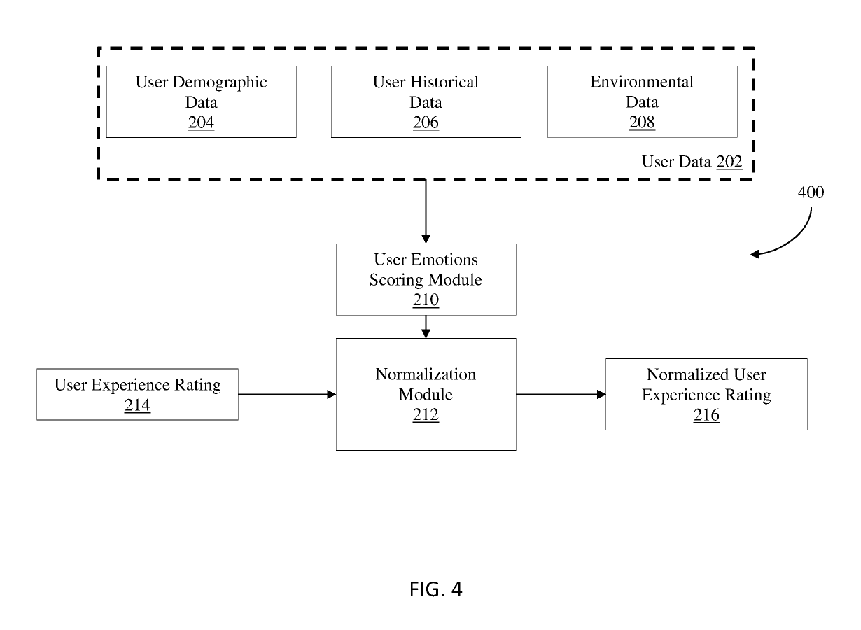

FIG. 4 is a block diagram illustrating a system 400 for normalizing user responses to events according to one or more embodiments. As shown in FIG. 4, the system 400 includes user data 202, a user emotion scoring module 210, a normalization module 212, a user experience rating 214, and a normalized user experience rating 216. In one or more embodiments, the user data 202 includes user demographic data 204, user historical data 206, and user environmental data 208.

In one or more embodiments, the user emotions scoring module 210 receives the user data 202 to determine an emotion score for a user based upon the user data. For example, user data 202 can include user historical data 206 that can include information about a user's work history. If the data indicates that the user has lost his or her job, then the emotional score of the user would be affected by this recent event in the user's life. This emotional score is then sent along to the normalization module 212 to normalize a user's response to an event. The user experience rating 214 includes ratings for events that occur in a user's life such as going to a restaurant, purchasing a new phone, going to a shopping mall, and the like. These ratings can be in the form of a numerical value such as, for example, a score based upon a scale of 1 to 10. Additionally, the ratings can be in the form of a star rating such as 1 star or 5 stars based upon a scale from 1 to 5 stars. The user experience rating 214 can be in the form of a post or comment left on a website for a product or service, or a social media post regarding the product or service.

In one or more embodiments, the user experience rating 214 is normalized by the normalization module based upon the user emotional score to determine a normalized user experience rating 216. The user data 202 includes user demographic data 204. The user demographic data 204 can be used to determine a user's traits. For example, some users may be predisposed to being happier while others may be more discontent. In one or more embodiments, the user demographic data 204 can include information on a user's knowledge of a particular subject. For example, a user may be a food critic with extensive knowledge on sushi so this particular user's rating or response to a sushi restaurant may be made based upon their extensive knowledge on the subject. Wherein the same user, may not know anything about steak restaurants so a review or a comment about the steak restaurant may not mean as much as the user's comments about the sushi restaurant. Some or all of the user emotions score can be attributed to the user's demographic data 204.

In one or more embodiments, the user data 202 includes user historical data 206 which includes information about the user's previous interactions and reactions to different events, products, services, and the like. The user historical data 206 can include recent events that could affect a user's response to an event such as, for example, a loss of job, a family member being diagnosed with an illness, losing money in the stock market, and the like. Additionally, the historical data can include events such as the birth of a child, a recent marriage, a promotion, and the like. These events can have either a long term or short term effect on a user's emotional response or reactions to different events. In addition, the user historical data 206 can include the user's preferences or a negative or positive bias about certain topics, services, or products. For example, a user that is a pet lover and vegetarian may have a strong response to products or services related to eating meat or any animal product. These strong responses may be present in a person who is otherwise relative tame and measured in their responses to other events not related to their personal biases. Some or all of the user emotions score can be attributed to the user historical data 202.

In one or more embodiments, the user data 202 includes environmental data 208 which includes information about the user's environment. For example, an environmental factor such as a long snow storm can affect a user's emotion which in turn can affect how a person reacts to a service, a product, or the like. Another example can be a nice, sunny day which may affect a user's emotions which would then affect any reactions a user may have to a service, product, or the like.

In one or more embodiments, the user data 202 can be obtained through data mining techniques for a user's social media data or other data from a user's calendar, emails, or any other sources that a user shares with the system 400.

In one or more embodiments, once the user emotion score is determined, the normalization module 212 alters the user experience rating based upon the user emotion score. The output is the normalized user experience rating 216. In one or more embodiment, the user emotion score can be a numerical value. For example, a user, user A, may have an emotion score of 49 on a 1 to 100 scale and another user, user B, may have a score of 89 where 100 is the most positive and 1 is the most negative. If user A makes a comment on a website or does a rating for a vacation destination and gives a rating of 99 on a scale from 1 to 100 and user B give a rating of 99 for the same vacation destination, the two scores would be normalized based upon each user's emotional score and the ratings would be given different weights. So in the present example, since user A's emotion score is lower than user B's emotion score, the rating from user A would carry more weight in determining the overall rating for this vacation destination. Since user B's emotion score is much more positive, the rating from user B would not carry as much weight in determining the overall rating for the vacation destination.

In one or more embodiment, the system 400 can be used to normalize a total rating for a particular good, product, or service on a social media network or on a website for rating goods, products, and services. Each review or rating can be normalized utilizing the techniques discussed above to adjust or normalize each user's ratings based upon the user data available to the social media network or the website. For example, if a restaurant review website has user data regarding the various users that provide reviews and ratings on their website, it can adjust the value of each rating based upon the historical user data, the demographic user data, and the environmental data for the user to obtain a more accurate picture of the ratings for particular restaurants featured on the website.

In one or more embodiments, user data 202 can include visual data (pictures or videos of the user) and biometric data (e.g. body temperature, heart rate, etc.) which can affect a user's emotions. Also, the visual data can be taken from sensors such as video cameras, web cameras, and the like. The visual data can also be taken from user profile pictures that a user utilizes for a social media service. Based upon this visual data, a user's facial expressions as determined by facial recognition software can be used to determine a user's emotional score. Also, a person's choice of wardrobe can also be used to determine a user's emotional score. The system 400 can be utilized in a physical shopping location within a shopping mall or grocery store to determine a user's emotional score while shopping at this location. Based upon changes in facial expression and body language, the system can determine an emotional score and reaction to different products as the user traverses the shopping location. This can be used to adjust advertisements and locations of certain goods or services while a user is shopping based upon their emotional score as determined by the visual data.

In one or more embodiments, the user data 202 can include biometric data taken from the wearable devices of a user, such as, for example, a smartphone, smartwatch, fitness band, and the like. This biometric data can include body temperature, heart rate, blood pressure, and the like. Based upon this biometric data, a user's emotional score can be obtained utilizing the method discussed above. For example, if a user's heart rate increases while viewing a product or service, this can be associated with a level of excitement for this product or service. As another example, if a user's blood pressure is high while viewing a product or service, this could indicate the user is annoyed or anxious while reviewing that product or service. If the user then makes a comment or rates the product or service, the rating or comment can be normalized based upon the user's emotional score, as determined by the biometric data or physiological data.

In one or more embodiments, the user data 202 can be taken from the text of a user's comments or ratings for a product or service. Based upon this textual data, the tone of the textual data can determine a user's emotional score. Certain word choices and the sequence of words can determine a user's tone to determine an emotional score. Additionally, the tone of the user's comments or ratings for a product or service can be used to determine a likelihood that the user is interested in purchasing a good or service.

In one or more embodiments, the user's emotion, in response to an event, can be affected by both the event itself and an outside factor. A user's emotional score can be normalized to show the emotion response to the event itself by removing this outside factor from consideration to analyze a user's response to an event. In one or more embodiments, this outside factor can be categorized into three different categories which affect the emotional score of the user. These three categories are: the long-term or habitual emotion of a user, the short term or temporary emotion of the user, and the spontaneous emotion of the user.

In one or more embodiments, the long-term or habitual emotion of a user can be determined based upon the user's demographic data 204. For example, with respect to reactions related to brand name products, a user's long-term or habitual emotion would be affected by the user's upbringing related to an environment that does not encourage the use of brand names, an environment that is surrounded by brand names, or if the user's environment causes the user to admire brand names. This would cause the user to react to brand names with a negative, neutral, or positive emotional score which would affect the user's ratings of certain brand names.

In one or more embodiments, a long-term or habitual emotion of a user can be determined from reactions to a type of event. For the reactions that have consistent emotion over a long period of time, the reaction is likely based on a habitual emotion. The emotional score of the user can be determined by comparing the user reaction to other users' reactions to the same event. For example, if a user's reaction is typically 10-20 (average of 15) degrees more negative compared to the average emotion to the same event from other users, then the user's emotional score could be 35 for this event on a 1 to 100 scale. On this scale, 50 is the median emotional score for a population and 100 is the most positive score. In one or more embodiments, another method for selecting a subset of users can be used instead of using the average emotion to the same event from all users. For example, other users with outlier emotions can be removed while other users with similar demographics to the user can be used. Another set of users can be other users that provided a response to 80% of events that the user has also provided responses. The events that a user has responded to can be grouped at a different granularity based on the scenario or needs. For example, product reviews for specific electronic products can be grouped together, as well as product reviews for the same type of electronic product can be grouped together. Products reviews for a specific electronic retailer can be grouped, but may be grouped at a different granularity than comments to blogs about positively supporting social security.

In one or more embodiments, a user can have a specific event with a product or service where the user then provides a response to that event. The long-term or habitual emotion of the user is determined from the available user data 202 and a timeline for this long term emotion of the user is determined. Additionally, from the available user data 202, a short-term or temporary emotion of the user can be determined along with a timeline of the temporary emotion. For example, a job loss occurring within the last three months would be utilized to determine a short term user emotion. Based upon the user's response to the event, the timing of the user's response is taken into consideration and compared to the short term and long term timeline of a user's emotion. If an impactful event, such as a job loss, has occurred at or around the time of the user's response, this impactful event is then analyzed to determine if it affects the user's response to the event. At the same time, the overall short and long term time frames can be analyzed to show the user's emotional distribution over time. Based upon the impactful event and the emotional distribution over time, the user's normalized emotion can be determined based upon their response to an event.

In one or more embodiment, impactful events to a user might not be known by the system 200. The changes of emotion from a user towards a type of event over a period of time can be used to identify the impactful event. If the user's attitude changed at a point of time, impactful events around that time can be determined from the user's data, such as social network data, calendars, phone call history, credit card statements, global positioning system (GPS) location, photographs, and the like. For example, if a user's emotion for product reviews turned negative three months ago, the user's data from three months ago can be analyzed. Should the user's calendar from three months ago show the user as “available all the time,” the system 200 could determine that the user was either on a vacation, had fallen ill, or the user may have been terminated from a job. Based on the negative change, the system 200 can determine that the change stems from a negative event instead of a positive event. Based upon this determination, the system may determine it more likely that the user has been terminated from a job versus the user being on vacation during that time period. Being terminated from a job is likely to impact many aspects of the user's life. Negativity towards a majority of events may be common for the user based upon this impactful negative event. However, should the user react negatively to only one event, while a large majority of other events receive a normal reaction from the user, then there might be other reasons that the user has become negative for that one event.

In one or more embodiment, a specific impactful event and details for the impactful event can be used for a business purpose. For example, revisiting the example above, becoming ill is going to impact the user for a temporary time period. Should it be determined that the user started to fall ill three months ago and the estimated recovery time is four months, then it can be projected that the user's emotion might revert to the normal state in, roughly, a month. When the user has recovered from the illness, this user may be more likely to purchase a product or service after seeing an advertisement. For example, the user might get a foodborne illness from a restaurant, which would cause the user to respond negatively to a food advertisement. Based on the determined impactful event, a tailored advertisement focusing on cleanliness of a restaurant can be provided to the user to insight a more positive response to the restaurant. In another example, the user might develop a new food allergy. The system 200 would determine that this is a permanent condition, and other similar food might receive a bad review from the user. Therefore, an advertisement for food items that the user is allergic to should not be shown to this particular user.

In one or more embodiment, a change of emotion due to an impactful event can be used to determine the changes to an emotional score of a user. For example, a user may have had an emotional score of 90 towards sports advertisements but it may have changed to 60 after the impactful event. When the user shows a score of 90, a group of other users including user B, user C, user D, and user E may show an average emotional score of 60. After an impactful sporting event, user B, user C, user D, and user E may show an average emotional score of 50. The system 200 may interpret that the emotional score towards the impactful sporting event has caused a decrease of 10. The emotional score of the user may show a decrease from 90 to 60, showing a total decrease of 30 points. When analyzing the impactful sporting event's general emotional score, a determination can be made that the emotional score of the user has actually decreased by 20 due to the impactful sporting event. In one or more embodiment, a user's gradual changing of the emotional score can be plotted over time and the user's future emotional score can be estimated.

In one or more embodiment, the system 400 can determine statistics about ratings and comments related to a population of users. For example, a distribution of ratings made by a user. This distribution can show a standard deviation for the user's ratings for various products or services. When determining a change in the user's emotional score, this distribution of ratings can be used to determine at what standard deviation does a change in a user's emotions seem to occur thus causing the system to determine the emotional score of the user normalize it.

In one or more embodiments, the system 400 can receive information from a loyalty card of a user. So when a user enters a store, the loyalty card will bring up information about the user. The system can then map known data about the user (i.e. user data 202) taken from social media, etc. and even order certain items from the store for the user. For example, if the system determines that a user (through a loyalty card or the like) has experienced a death in the family, the store that the loyalty card is with can order flowers for the user or even make sure it has in stock goods or services for funerals, wakes, etc.

In one or more embodiments, the system 400 can receive requests from a product review website. After a user submits a product review on the website, the product review website can request, from the system 400, the emotional score of the user of the product at the time when the user created or submitted the review. The rating made by the user on the product review website can be normalized based on the emotional score of the user. In one or more embodiments, when a second user views the reviews for a product a host of information will be available including, all the product reviews, all of the original ratings created by multiple different reviewers, and one or more of the normalized ratings for the multiple different reviewers. A rationale extracted from an impactful event for each of the multiple different reviewers will also be available to the second user. In one or more embodiments, statistical calculations, such as mean, median, mode, and standard deviation can be applied to both the normalized product review and the original product review.

In one or more embodiments, the system 400 can receive requests from an advertiser. An advertiser, including advertising individuals or advertising computing systems responsible for advertisement generation, can request an emotional state of one or more users. An advertiser can also request, from the system 400, projected emotional changes in the future and impactful events of one or more users. Based on the information provided, the advertiser can decide on the appropriate advertisement and the timing to send an advertisement to the users. For example, if a user is projected to recover from an illness in one month, the advertiser can defer certain types of advertisements to that user until one month later.

In one or more embodiments, the system 400 can be utilized by a user. The emotional changes of the user can be reviewed by the user who is interested to improve his or her emotional intelligence. In addition, the user can use the system 400 to adjust a product rating before posting to a product review website. In one or more embodiments, the user can use the system 400 to uncover impactful event and selectively hide or erase the impactful event from public access.

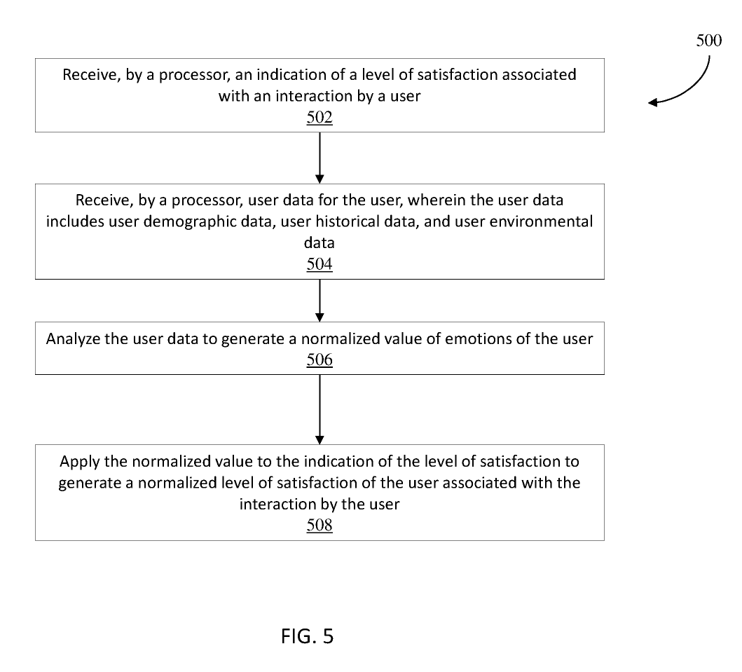

FIG. 5 illustrates a flow diagram of a method 500 for normalizing user responses to events according to one or more embodiments. As shown in block 502, the method 500 includes receiving, by a processor, an indication of a level of satisfaction associated with an interaction by a user. Next, at block 504, the method 500 receives, by a processor, user data for the user, wherein the user data includes user demographic data, user historical data, and environmental data. At block 506, the method 500 analyzes the user data to generate a normalized value of emotions of the user. At block 508, the method 500 applies the normalized value to the indication of the level of satisfaction to generate a normalized level of satisfaction of the user associated with the interaction by the user.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for normalizing user responses to events, the method comprising:
receiving, by a processor, an indication of a level of satisfaction associated with an interaction by a user;
receiving, by the processor, user data for the user;
analyzing the user data to generate a normalized value of emotions of the user; and
applying the normalized value to the indication of the level of satisfaction to generate a normalized level of satisfaction of the user associated with the interaction by the user.

2. The method of claim 1, wherein the indication of the level of satisfaction associated with the interaction by the user is a numerical rating generated by the user.

3. The method of claim 1, wherein the interaction by the user includes at least one of a service, a product, and an advertisement.

4. The method of claim 1, further comprising:
adjusting the normalized value based upon a passage of time relative to the user data for the user.

5. The method of claim 1, further comprising:
obtaining a tone of the indication of the level of satisfaction; and
analyzing the tone of the indication of the level of satisfaction to determine a confidence value associated with a likelihood of the user purchasing a service or product.

6. The method of claim 1, wherein the user data includes user demographic data, user historical data, and user environmental data.

7. The method of claim 6, wherein user environmental data includes sensor data received from a sensor regarding the user.

8. The method of claim 6, wherein the user historical data includes past indications of the level of satisfaction associated with in interaction by the user.

9. The method of claim 1, where the indication of the level of satisfaction includes at least one of a post on social media, a comment on a product website, and a rating on a service website.

10. A system for normalizing user responses to events, the system comprising:
a memory; and
a processor communicatively coupled to the memory, wherein the processor is configured to:
receive an indication of a level of satisfaction associated with an interaction by a user;
receive user data for the user;
analyze the user data to generate a normalized value of emotions of the user; and
apply the normalized value to the indication of the level of satisfaction to generate a normalized level of satisfaction of the user associated with the interaction by the user.

11. The system of claim 10, wherein the indication of the level of satisfaction associated with the interaction by the user is a numerical rating generated by the user.

12. The system of claim 10, wherein the interaction by the user includes at least one of a service, a product, and an advertisement.

13. The system of claim 10, further comprising:
the processor configured to:
adjust the normalized value based upon a passage of time relative to the user data for the user.

14. The system of claim 10, further comprising:
the processor configured to:
obtain a tone of the indication of the level of satisfaction; and
analyze the tone of the indication of the level of satisfaction to determine a confidence value associated with a likelihood of the user purchasing a service or product.

15. The system of claim 10, wherein the user data includes user demographic data, user historical data, and user environmental data.

16. The system of claim 15, wherein user environmental data includes sensor data received from a sensor regarding the user.

17. The system of claim 15, wherein the user historical data includes past indications of the level of satisfaction associated with in interaction by the user.

18. The system of claim 10, where the indication of the level of satisfaction includes at least one of a post on social media, a comment on a product website, and a rating on a service website.

19. A computer program product for normalizing user responses to events, the computer program product comprising a computer readable storage medium having program instructions embodied therewith, wherein the computer readable storage medium is not a transitory signal per se, the program instructions executable by a processor to cause the processor to perform a method comprising:
receiving, by a processor, an indication of a level of satisfaction associated with an interaction by a user;
receiving, by a processor, user data for the user;
analyzing the user data to generate a normalized value of emotions of the user; and
applying the normalized value to the indication of the level of satisfaction to generate a normalized level of satisfaction of the user associated with the interaction by the user.

20. The computer program product of claim 19, wherein the user data includes user demographic data, user historical data, and user environmental data.
